(19) United States
(12) Patent Application Publication
(10) Pub. No.: US 2005/0125226 A1
(43) Pub. Date: Jun. 9, 2005

(54) Voice recognition system and method

(76) Inventor: Paul Magee, West Pennant Hills (AU)

Correspondence Address: ST. ONGE STEWARD JOHNSTON & REENS, LLC, 986 BEDFORD STREET, STAMFORD, CT, 06905-5619, US

(21) Appl. No.: 10/975,859

(22) Filed: Oct. 28, 2004

(30) Foreign Application Priority Data
Oct. 29, 2003 (AU) 2003905970

(51) Int. Cl. G10L 17/00

(52) U.S. Cl. 704/246

(57) ABSTRACT

In a voice transmission system, a method of reducing the likelihood of identity theft, the method including the steps of: (a) recording the voice of a series of users and deriving a corresponding voiceprint from each voice, the voiceprint having at least a corresponding first series of measurable identification features associated with the voice. (b) —for a new voice introduced to the authentication system: deriving a new voiceprint for the new voice; and comparing the new voiceprint with voiceprints stored in the database to determine correlations there between.

This application claims priority from pending Australian Patent Application No. 2003905970 filed on Oct. 29, 2003.

### FIELD OF THE INVENTION

The present invention relates to the field of voice recognition and identification and, in particular, discloses a system and method for authenticating user's voices.

### BACKGROUND OF THE INVENTION

Recently, there has been a substantial increase in instances of identity fraud or the “hijacking” of someone's identity information. This can include the utilization of other person's credit card or social security numbers to steal money or commit fraud.

One example instance of identity fraud involves an individual claiming more than one identity (claiming to be more than one person) with the intent of defrauding a Government department or a financial institution to receive extra social welfare payments or access to credit facilities.

In Australia, it is estimated that 25% of fraud reported to the Australian Federal Police involve false identity. According to Westpac Bank, information on 13% of birth certificates does not match official records, and in 1999 Centrelink detected $12 million of fraud involving false identity (1999).

In US, 6% of revenue is thought to be lost through fraud; with the US Government estimating that US$25 billion is lost to identity thieves. Likewise the FBI estimates that there are between 350,000-500,000 instances of identity theft in the US alone.

All of these estimates are thought to be conservative.

In the area of electronic commerce identity authentication become even more difficult to manage. Traditionally accepted security measures for call centers and general Internet activity are Personal Identification Numbers (PIN) and/or a password of some sort. However, PIN's and passwords are easily stolen, easily forgotten and shared. Once compromised, there is a great deal of difficultly involved in re-establishing the correct identity.

### SUMMARY OF THE INVENTION

It is an object of the present invention to provide for an improved form of client identification system and method.

In accordance with a first aspect of the present invention, there is provided a method of detecting a likelihood of voice identity fraud in a voice access system, the method comprising the steps of: (a) storing a database of voice characteristics for users of the voice access system; (b) for a new user of the system: (i) determining a corresponding series of voice characteristics for the new user's voice; (ii) reviewing the database of voice characteristics to determine voices having similar voice characteristics; (iii) reporting on the users within the database having similar voice characteristics.

The method can further include the step of sorting the database into candidates likely to commit voice identity fraud and reviewing only those candidates likely to commit voice identity fraud. The method can also include the step of producing a series of comparison results comparing a new users voice with a series of different voice characteristics and combining the comparison results into an overall comparison measure.

In accordance with a further aspect of the present invention, there is provided a method of detecting a likelihood of voice identity fraud in a voice access system, the method comprising the steps of: (a) storing a database of voice characteristics for users of the voice access system; (b) for a user of the system suspected of voice identity fraud: (i) determining a corresponding series of voice characteristics for the suspected user's voice; (ii) reviewing the database of voice characteristics to determine voices having similar voice characteristics; (iii) reporting on the users within the database having similar voice characteristics.

The method can also include the step of: reporting all access to by a particular user of the system.

In accordance with a further aspect of the present invention, there is provided a method of detecting a likelihood of voice identity fraud in a voice access system, the method comprising the steps of: (a) storing a database of voice characteristics for users of the voice access system; (b) continually searching the database for instances of similarity of voice characteristics between users; (c) periodically reporting on the users within the database having similar voice characteristics.

In accordance with a further aspect of the present invention, there is provided in a voice transmission system, a method of reducing the likelihood of identity theft, the method including the steps of: (a) recording the voice of a series of users and deriving a corresponding voiceprint from each voice, the voiceprint having at least a corresponding first series of measurable identification features associated with the voice. (b) —for a new voice introduced to the authentication system: deriving a new voiceprint for the new voice; and comparing the new voiceprint with voiceprints stored in the database to determine correlations there between.

Preferably, the method also includes accepting or rejecting that the new voice is correlated with a particular owner depending on the comparison.

Preferably, the method also includes the step of periodically searching the database of voiceprints to determine if any of the voiceprints exceed a predetermined level of correlation to one another.

### BRIEF DESCRIPTION OF THE DRAWINGS

Preferred embodiments of the present invention will now be described with reference to the accompanying drawings in which:

FIG. 1 illustrates schematically a first arrangement of the first embodiment;

FIG. 2 illustrates a flow chart of the steps in the preferred embodiment;

FIG. 3 illustrates schematically in more detail an arrangement of an embodiment;

### DESCRIPTION OF PREFERRED AND OTHER EMBODIMENTS

The following terms and notation will be used in describing the preferred and other embodiments.

The embodiment as a whole is called an authentication system. The embodiment includes at least one biometric identification system. The purpose of the authentication system is to control access to one of a plurality of protected resources.

The authentication system stores information regarding a number of identities. An identity within the authentication system is denoted by id. Multiple identities are denoted id₁, id₂, etc. If multiple biometric identification systems are used, the data for identity id that pertains to biometric system A is denoted id^{A}.

A unique person is denoted by p. Multiple people are denoted p₁, p₂, etc. Note that it is possible that a given person may create multiple identities within the authentication system.

The unique person who constructed a given identity id is denoted person(id).

Ideally, for each person p who can access the protected resources, there is exactly one identity id that that person can use to access the protected resources. The purpose of this invention is to provide means to detect cases where a person p has access to the system using a plurality of identities.

It is assumed that there exists a set of raw data that can be obtained from a person p that a biometric identification system can use for its operations. A set of raw data gathered from a person p in order to interact with the system is denoted r. The set of raw data used to create a particular identity id is denoted raw(id). If multiple biometric identification systems are used, they may not use the same raw data. If a number of sets of raw data are gathered to form an identity for multiple biometric systems, the data pertaining to biometric system A is denoted r^{A}. The set of raw data used to create a particular identity id that pertains to biometric system A is denoted raw^{A}(id). This is defined to be same as raw(id).

The unique person from whom a set of raw data r was obtained is denoted person(r). It is possible that the process of creating an identity may take place under different conditions to the process of establishing identity in general; this creation process is called enrolment in much of the industry literature.

It is possible, but not required, that the biometric system extracts information from the set of raw data used to create an identity to form a biometric print representing important characteristics of the person. A bioprint generated from a set of raw data is denoted b. The identity represented by a bioprint b is denoted identity(b). The bioprint associated with an identity id is denoted bioprint(id). If multiple biometric identification systems are used, they may require different bioprint data. The bioprint data pertaining to biometric system A is denoted b^{A}. The bioprint data associated with an identity id that pertains to biometric system A is denoted bioprint^{A}(id). The raw data used to generate a bioprint b is denoted raw(b); this is shorthand for raw(identity(b)). The unique person from whom raw data was taken to generate a bioprint b is denoted person(b); this is shorthand for person(raw(b)). The superscript notation used to denote particular biometric systems is applied similarly here as appropriate.

It is assumed that regardless of whether a bioprint is used, the biometric system is at least capable of establishing the estimated likelihood that a given set of raw data r was obtained from the same person as that who created the identity id, denoted as likelihood (r,id). That is, it is assumed that the biometric system can return an estimated likelihood/that:
person(r)=person(id)

In the case where bioprints are used, this is most likely implemented as estimating the likelihood/that:
person(r)=person(bioprint(id))

In the case where bioprints are not used, this is most likely implemented as estimating the likelihood/that:
person(r)=person(raw(id))

Note that these likelihood measurements are not probabilities: they are assumed to be dimensionless numbers for later processing by the system.

In the preferred embodiment, a series of biometric techniques are utilized to determine an individual's identity. In particular, voice and speech verification technologies are utilized. The biometrics can include a range of technologies that use specific physical and/or behavioural characteristics unique to each individual to either establish or confirm the identity of that individual. These can include:
Iris scanning which utilizes the unique pattern of the iris;
Speaker verification which utilizes unique voice characteristics of the author;
Finger and palm prints which utilize unique patterns of the fingers and palms; and
Face recognition which utilizes recognition of face characteristics.

Other biometric techniques such as DNA testing or even photographic identification can be utilized. In the formal terms used in the preamble to this text, the raw data for an iris scan might be a detailed picture of the iris, and the bioprint a set of measurements and information about the iris; for speaker verification, a recording of some speech and a corresponding set of measurements of the person's vocal tract; for finger and palm prints detailed images and measurements of print patterns; for face recognition a picture of the face and proportions of the face.

The preferred embodiment utilizes speaker verification technology. These technologies normally rely on the unique characteristics of a person's voice to create a distinct voice identifier which can be captured over the telephone, verified reliably and appended permanently to an individual consumer's ID credentials.

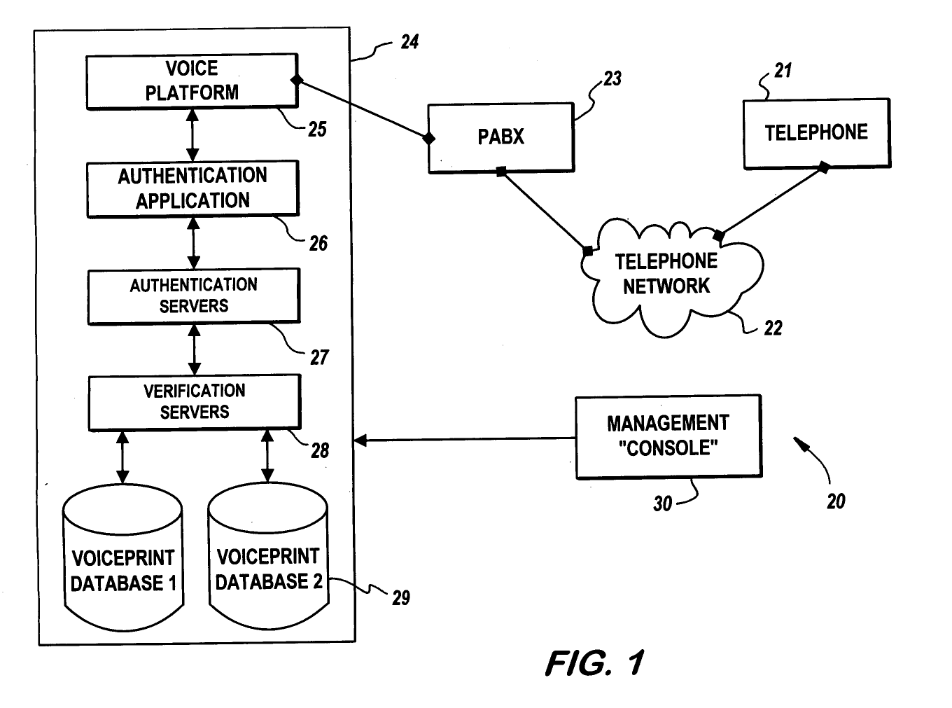

Turning initially to FIG. 1, there is illustrated schematically the hardware arrangement of the preferred embodiment 20, wherein a user utilizes a telephone 21 over the public telephone network 22 to interconnect with a PABX type device 23. The PABX device 23 is interconnected to a computer system 24 which can comprise a plurality of high end PC (Linux or other) based systems. These systems include a plurality of servers with software running a voice platform for implementing the interaction with callers 25, a plurality of servers presenting the authentication application to the caller 26, a plurality of servers including software to manage the authentication processes described in this document 27, and a plurality of verification servers 28 which utilizes a plurality of voice print databases 29. In addition there is an interactive console to manage these servers 30. It is anticipated that while the preferred embodiment includes a plurality of each of the different kinds of servers, some embodiments may combine functions of some servers to reduce the number required or improve performance of the system.

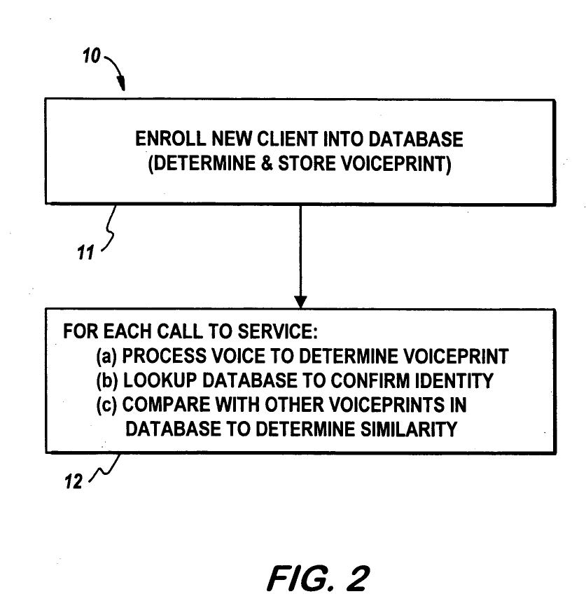

Turning to FIG. 2, there is illustrated 10, the steps involved in the preferred embodiment. In the preferred embodiment, the first stage 11 is an enrolment process. This procedure involves each user of a service speaking to or calling the system for a short while so as to form a reliable set of data regarding the user's voice. This set of data is either stored raw (as recordings of the user's speech), stored as a biometric print (as some set of data representing distinctive characteristics of the user's voice), or in the preferred embodiment, both. Preferably, any data stored regarding a user's speech (either raw speech or a bioprint) is encrypted and stored in a database.

After a user has been enrolled in the system, for each subsequent call to the service 12, the user's voice is processed to determine a voiceprint. The database is then accessed to confirm the user's identity in addition to comparing the caller's voiceprint with other voiceprints within the database to determine their similarity. Based on the comparisons, the caller is accepted or rejected.

The computers providing the authentication and verification facilities and the voice print database are preferable located within a high security facility.

Many different speaker verification technologies can be utilized. The preferred embodiment is designed to operate with many different known packages for producing voice signatures. Suitable technologies are widely available from companies such as ScanSoft, Inc with their SpeechSecure software, and Nuance Communications Inc. with Nuance Verifier. Both products utilize biometric technology to verify a caller's identity based on the characteristics of his or her unique vocal patterns. In one embodiment, many different speaker verification technologies are utilized and a voting process carried out. The database systems can be based upon standard SQL server type arrangements also readily available from companies such as Oracle and Microsoft.

Preferably, the system includes a mechanism to bring together all information available to turn the results from the plurality of biometric systems into a probability that the user matches a particular identity. In the formal language described in the preamble to this discussion, if three biometric systems A, B and C are used to determine whether a particular set of raw data r matches an identity id, then the system preferably includes a mechanism to establish the probability that the person who generated the raw data r also generated the raw data sets used to generate id^{A}, id^{B}, and id^{C}. In more formal notation, the system includes a mechanism to estimate:

$${p}_{estimate} ( \begin{matrix} ( person ( r ) = person ( {id}^{A} ) ) ⋀ \\ ( person ( r ) = person ( {id}^{B} ) ) ⋀ \\ ( person ( r ) = person ( {id}^{C} ) )\end{matrix} ) = {f}_{same - caller} ( \begin{matrix} {likelihood}^{A} ( r , {id}^{A} ) , \\ {likelihood}^{B} ( r , {id}^{B} ) , \\ {likelihood}^{C} ( r , {id}^{C} )\end{matrix} )$$

This can be extended or reduced to match the actual number of biometric identification systems used in the obvious manner.

This assumes that all the biometric identification systems operate most efficiently from the same type of raw data. If this is not the case, the formal notation is:

$${p}_{estimate} ( \begin{matrix} ( person ( {r}^{A} ) = person ( {id}^{A} ) ) ⋀ \\ ( person ( {r}^{B} ) = person ( {id}^{B} ) ) ⋀ \\ ( person ( {r}^{C} ) = person ( {id}^{C} ) )\end{matrix} ) = {f}_{same - caller} ( \begin{matrix} {likelihood}^{A} ( {r}^{A} , {id}^{A} ) , \\ {likelihood}^{B} ( {r}^{B} , {id}^{B} ) , \\ {likelihood}^{C} ( {r}^{C} , {id}^{C} )\end{matrix} )$$

The algorithm to establish whether the caller matches the specified identity must account for the different performance of the biometric identification systems, including the fact that their scores are unlikely to be independent of each other.

Note also that it is preferred—and hoped—that:
person(id^{A})=person(id^{B})=person(id^{C})

The preferred embodiment has a mechanism to check this assumption during the enrolment process. If the different biometric systems used operate most effectively from the same set of raw data r, no checking is required: one set of raw data r is gathered from a single person p, thus ensuring that a single person created all the information required for each biometric system. If the biometric systems operate most effectively with different sets of raw data, but can nonetheless perform some verification with other data, a given biometric system can be used to check the likelihood that the data used for another biometric system matches that used for its own purposes. In the formal language again, if biometric systems A, B, and C use different but related raw data (for example, both use speech, but one operates most effectively with the digits one through nine, one other operates most effectively using the phrase ‘my voice is my password’, and one with the phrase ‘the quick brown fox’), the three sets of raw data gathered might be denoted r^{A}, r^{B}, and r^{C}.

To establish the probability that the person who generated the one through nine data is the same person as that who generated the two sets of phrase data, the preferred embodiment uses the biometric systems A, B, and C to test the other's data. That is, the preferred embodiment includes an algorithm to compute the probability that the same person provided all sets of raw data. In the formal notation:

$${p}_{estimate} ( \begin{matrix} ( person ( {r}^{A} ) = \\ ( person ( {r}^{B} ) = \\ ( person ( {r}^{C} )\end{matrix} ) = {f}_{same - enroller} ( \begin{matrix} {likelihood}^{A} ( {r}^{B} , {id}^{A} ) , \\ {likelihood}^{A} ( {r}^{C} , {id}^{A} ) , \\ {likelihood}^{B} ( {r}^{A} , {id}^{B} ) , \\ {likelihood}^{B} ( {r}^{C} , {id}^{B} ) , \\ {likelihood}^{C} ( {r}^{A} , {id}^{C} ) , \\ {likelihood}^{C} ( {r}^{B} , {id}^{C} )\end{matrix} )$$

The algorithm to merge likelihood scores from the enrolment process must take into consideration the differing performance of each of the biometric identification systems when processing raw data that is not in the optimal form for that system. The combining factors can be derived experimentally.

Five different modes of detecting identity related fraud utilizing speaker verification and the associated voice print database and identity management software are provided in the preferred embodiment.

In a first mode of operation, a complementary “cross matching” system is provided which highlights instances of multiple claimed identities by searching the database of those enrolled voices to specify highly similar instances of an individual's voice. A ranking of the orders of similarity can be returned. The search space may be limited by external information, such as a list of identities more likely to be involved with fraud. The result space, and preferably the search space, may be limited by specifying the threshold probability desired in the output. For example, the user might choose to only view matches where the probability of two identities belonging to the same person is greater than 0.8. In formal notation, this would be represented as:
A={members of the authentication database}
T={id|idεA \hat{ }id is a possible candidate for identity fraud}
S={(id₁id₂, pₑₛₜᵢₘₐₜₑ)|id₁εT\hat{ }pₑₛₜᵢₘₐₜₑ(person(id₁)=person(id₂)≦threshold)}

Note that the set T might be the same as the set A, if all identities are candidates for identity fraud.

This somewhat loose search could be tightened by enforcing that both identities must come from the suspected fraudulent set. In that case, the set becomes:

$$S = \{ ( {id}_{1} , {id}_{2} , {p}_{estimate} ) \vert ( \begin{matrix} {id}_{1} ∈ T ⋀ \\ {id}_{2} ∈ T ⋀ \\ {p}_{estimate} ( person ( {id}_{1} ) = person ( {id}_{2} ) ) \geq threshold\end{matrix} ) \}$$

The probability estimate is formed from the basic operations of the biometric identification systems, along with the algorithm for bringing the set of likelihood data together to form a probability. Specifically:

$${p}_{estimate} ( person ( {id}_{1} ) = person ( {id}_{2} ) ) = {f}_{same - caller} ( \begin{matrix}\begin{matrix} {likelihood}^{A} ( raw ( {id}_{1}^{A} ) , {id}_{2}^{A} ) , \\ {likelihood}^{B} ( raw ( {id}_{1}^{B} ) , {id}_{2}^{B} ) ,\end{matrix} \\ {likelihood}^{C} ( raw ( {id}_{1}^{C} ) , {id}_{2}^{C} )\end{matrix} )$$

If the underlying biometric identification systems offer optimizations to allow simultaneous comparison, these are used to improve performance.

A second mode of operation involves detecting the identity-related fraud upon registration. Upon registration, the system compares the voiceprint being registered with other voiceprints in the database of existing voiceprints and the computer produces a ranking of similarity scores for all the voiceprints in the database. Preferably, a probability of similarity score is produced. The computations undertaken are similar to the first mode of operation, including the possibility of informing the search space with suspicious identities, and including the threshold probability to report. Formally, if the identity being enrolled is idₜₑₛₜ:
A={members of the authentication database}
T={id|idεA\hat{ }id is a possible candidate for identity fraud}
S={(idₜₑₛₜ, id,pₑₛₜᵢₘₐₜₑ)idεT\hat{ }pₑₛₜᵢₘₐₜₑ(person(idₜₑₛₜ)=person(id)≦threshold)}

The means of establishing the probability are exactly the same as for the first mode of operation.

In the preferred embodiment, if this enrolment testing generates a non-empty set of possible voice print matches (based on the threshold), an operator can become involved, who can then scan the set to determine if it is likely that the individual registering has previously registered. In another possible embodiment, all calls involve an operator, and if a similarity match is not recorded, the operator can proceed to register the person's voice in the database under a new unique identity tag. In another possible embodiment, no operators are involved, and suspicious enrolments are flagged for future investigation.

In a third mode of operation, where an individual is suspected of identity related fraud, the database can be searched to retrieve the voiceprint for the individual. This voiceprint can then be compared against all other entries in the database to produce a report of probably instances of similar voices. The probable instances can then be investigated. The means to establish the set of similar voiceprints is the same as that described in the second mode of operation. The computations undertaken are similar to the first mode of operation, including the possibility of informing the search space with suspicious identities, and including the threshold probability to report. Formally, if the identity under question is idₜₑₛₜ:
A={members of the authentication database}
T={id|idεA\hat{ }id is a possible candidate for identity fraud}
S={(idₜₑₛₜ,id,pₑₛₜᵢₘₐₜₑ)|idεT\hat{ }pₑₛₜᵢₘₐₜₑ(person(idₜₑₛₜ)=person(id)≦threshold)}

The means of establishing the probability are exactly the same as for the first mode of operation.

In a fourth mode of operation, the voice print database can be continually searched to extract instances of suspected identity related fraud. In this mode of operation, the database is continually searched to produce a ranking of similar voiceprints. The information can then be investigated so as to determine likely instances of identity related fraud. The searching algorithms, information and probability thresholds are the same as for the first mode of operation.

In a further mode of operation, the verification server can be designed to report each time a particular individual's voiceprint has been activated and the result of that activation (i.e. did the system confirm or decline the claimed voice identity).

The system can be set up for individuals registered with the system and system managers or law enforcement agencies to obtain reports detailing utilization of a voiceprint. This would then enable these people/agencies to detect suspected instances of fraud when for example, if a claimed identity against a single voiceprint is repeatedly rejected. In another example, an individual may suspect that someone is trying to defraud them by, say, using a stolen credit card or personal information. In this example, the individual concerned could independently check activity on their voiceprint by obtaining an activity statement, which may include the time of use and the results of identity checks and this can be checked against the user's own personal records.

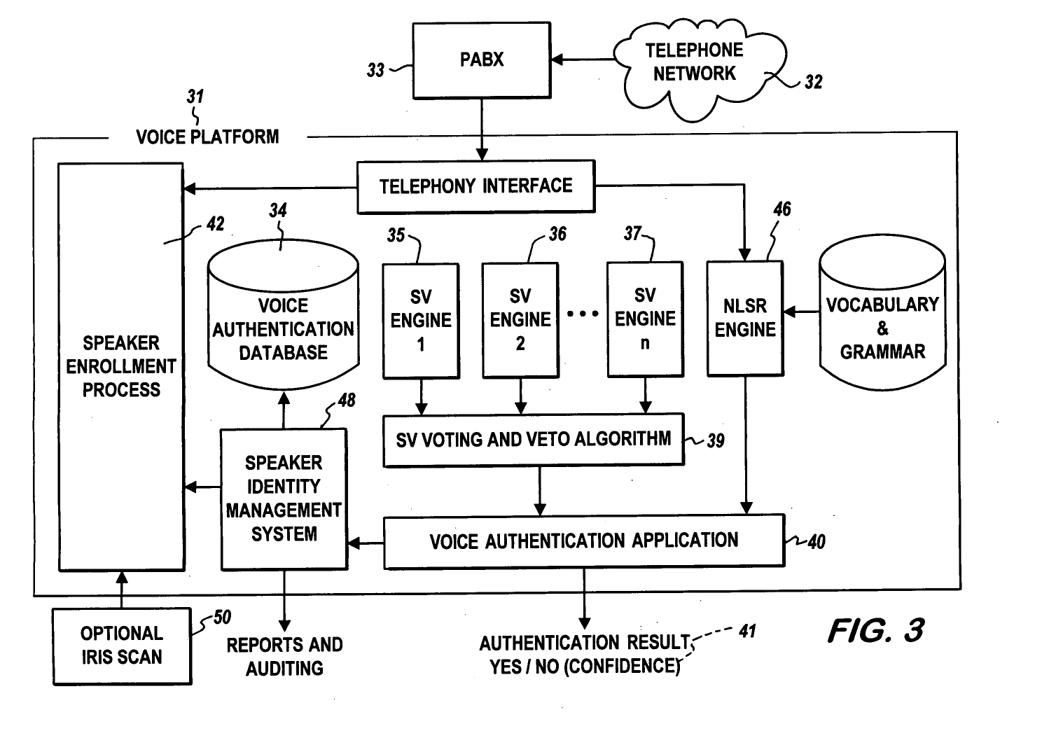

Turning now to FIG. 3, there is illustrated schematically, a modified embodiment of the present invention. In this arrangement, the verification server 31 is interconnected to the telephone network 32 via a PABX 33 in the usual manner. A voice authentication database 34 stores voiceprint information. A series of speaker verification modules 35-37 are provided with the modules interacting with the voice identification database to determine a closeness match for a voiceprint. The outputs from the speaker verification modules are forwarded to speaker verification and voting veto algorithms section 39 which votes on the results output and produces verification information which is forwarded to voice authentication application 40 before output 41.

New speakers are forwarded to the speaker enrolment process 42 which provides for the process of deriving voiceprints for storage in voice authentication database 34. The interaction with the user can be provided by natural language speech response engine 46 which asks the user a series of questions as part of the enrolment purposes and records the response.

Callers can first enroll in the system as predicated by the scope of the end-application. This can be performed by the enrolment software 42 which can be controlled a voice authentication application and can be optionally controlled by another biometric technology which prevents unauthorized registration of identities. The other biometric technology can include Iris scanning technology e.g. 50.

If Mode 1 is selected (‘cross-matching on enrolment’), the management software can initiate a session on the voiceprint database 34 to look for similar voiceprints and return this to the enrolment process. The enrolment process can then be altered if there were an unfavourably high number of similar voiceprints. At this point there can be a number of options to continue, including transfer of the caller to a live operator.

If Mode 2 is selected, “cross matching” is performed by the system manager using the speaker identity management software 48. The system can be configured such that only an administrator registered with the optional biometrics security device may initiate “cross-matching” of a selected individual's voice print with the rest of the database. The cross-matching result can be reported by the speaker verification identity management software.

If Mode 3 is selected, a general “sweep” of the speaker verification database 34 can be initiated by a system administrator. In this event every voiceprint entry can be cross checked against every other voiceprint entry and the result reported using the speaker verification identity management system.

If Mode 4 is selected, registered users could, via a specific voice application or other means, request an activity report on the use of their voiceprint. This report can include:—
Date and time the voiceprint was activated
The result of the voiceprint matching (i.e. was the voice print match successful or not)
The services for which authentication was requested
The telephone number used to access the voiceprint system (if available).

The registered individual can then use this information to check against their records to determine if an unauthorized party was trying to use their voiceprint identity credential.

To investigate possible instances of identity related fraud based on any number of indicators, a law enforcement agency or similar body can, via a series of commands and controls via the management software and system, extract an instance of a claimed identity from the voiceprint database and then initiate a database look-up to extract a ranking of similar voiceprints and their identifiers. The ranking probability and weighting is controlled from the management software. Once the ranking is retrieved, the agency can then further utilize this information.

To provide maintenance and ongoing compliance of identity management voiceprint databases, the management software and system can also be configured to detect, in a scheduled/unattended manner, closely matching voices providing an indication that the same person may have enrolled on multiple occasions.

To provide users of the system with the knowledge of when and where their identity has been claimed, the management software and system can provide a report detailing the activity of an associated voiceprint.

The foregoing describes preferred forms of the invention only. Modifications, obvious to those skilled in the art can be made there to without departing from the scope of the invention.

1. A method of detecting a likelihood of voice identity fraud in a voice access system, the method comprising the steps of:
(a) storing a database of voice characteristics for users of the voice access system;
(b) for a new user of said system:
(i) determining a corresponding series of voice characteristics for the new user's voice;
(ii) reviewing the database of voice characteristics to determine voices having similar voice characteristics;
(iii) reporting on the users within the database having similar voice characteristics.

2. A method as claimed in claim 1 further comprising the step of: sorting said database into candidates likely to commit voice identity fraud and reviewing only those candidates likely to commit voice identity fraud.

3. A method as claimed in claim 1 further comprising the step of producing a series of comparison results comparing a new users voice with a series of different voice characteristics and combining the comparison results into an overall comparison measure.

4. A method of detecting a likelihood of voice identity fraud in a voice access system, the method comprising the steps of:
(a) storing a database of voice characteristics for users of the voice access system;
(b) for a user of said system suspected of voice identity fraud:
(i) determining a corresponding series of voice characteristics for the suspected user's voice;
(ii) reviewing the database of voice characteristics to determine voices having similar voice characteristics;
(iii) reporting on the users within the database having similar voice characteristics.

5. A method as claimed in claim 4 further comprising the step of:
reporting all access to by a particular user of said system.

6. A method of detecting a likelihood of voice identity fraud in a voice access system, the method comprising the steps of:
(a) storing a database of voice characteristics for users of the voice access system;
(b) continually searching said database for instances of similarity of voice characteristics between users;
(c) periodically reporting on the users within the database having similar voice characteristics.

7. In a voice transmission system, a method of reducing the likelihood of identity theft, the method including the steps of:
(a) recording the voice of a series of users and deriving a corresponding voiceprint from each voice, said voiceprint having at least a corresponding first series of measurable identification features associated with said voice.
(b) for a new voice introduced to the authentication system:
deriving a new voiceprint for said new voice; and comparing said new voiceprint with voiceprints stored in said database to determine correlations there between.

8. A method as claimed in claim 7 further comprising accepting or rejecting the new voice as correlated with a particular owner depending on said comparison.

9. A method as claimed in claim 1 further comprising the step of searching the database of voiceprints to determine if any of the voiceprints exceed a predetermined level of correlation to one another.

10. A method as claimed in claim 8 wherein said search is conducted periodically.
